(19) United States
(12) Patent Application Publication
(10) Pub. No.: US 2021/0190617 A1
(43) Pub. Date: Jun. 24, 2021

(54) SENSOR ELEMENT AND METHOD FOR MANUFACTURING SAME, AND SENSOR DEVICE

(71) Applicant: HITACHI AUTOMOTIVE SYSTEMS, LTD., Hitachinaka-shi (JP)

(72) Inventors: Takuya AOYAGI, Ibaraki (JP); Ryo ANDO, Ibaraki (JP); Kazuhiro OHTA, Ibaraki (JP); Kengo SUZUKI, Ibaraki (JP); Hiroshi ONUKI, Ibaraki (JP); Yasuo ONOSE, Ibaraki (JP); Hiroshi NAKANO, Tokyo (JP)

(73) Assignee: HITACHI AUTOMOTIVE SYSTEMS, LTD., Hitachinaka-shi, Ibaraki (JP)

(21) Appl. No.: 16/754,792

(22) PCT Filed: Oct. 10, 2018
(86) PCT No.: PCT/JP2018/037656

§ 371 Date: Apr. 9, 2020

(30) Foreign Application Priority Data
Oct. 23, 2017 (JP) 2017-204556

(51) Int. Cl. G01L 9/04; G01N 27/18; G01N 25/18; G01L 9/00; G01L 19/00

(52) U.S. Cl. CPC G01L 9/045; G01N 27/18; G01L 19/0092; G01L 9/0051; G01N 25/18

(57) ABSTRACT

Provided is a sensor element that can be manufactured without using hydrofluoric acid or hot phosphoric acid solution. A sensor element 100 includes a base material 10 and a semiconductor chip 20 bonded to the base material 10. The semiconductor chip 20 includes a semiconductor substrate 21, a support film 22 provided on a surface 21a of the semiconductor substrate 21, and a substrate chamber 23 provided in a concave shape on the semiconductor substrate 21 to form a cavity facing an element region 22A of the support film 22, an insulating layer 24 provided on a rear surface 21b of the semiconductor substrate 21, and a bonding layer 25 provided between the insulating layer 14 and the base material 10. The insulating layer 24 includes at least one of a silicon oxynitride film and a silicon oxide film. The bonding layer 25 includes a low-melting point glass.

### TECHNICAL FIELD

The present invention relates to a sensor element, a method for manufacturing the same, and a sensor device.

### BACKGROUND ART

Conventionally, an invention relating to a physical quantity detection device for detecting a physical quantity of a gas is known (see PTL 1 below). PTL 1 discloses a physical quantity detection device that is mounted to an intake system of an internal combustion engine and detects a physical quantity of intake air. The physical quantity detection device includes a semiconductor substrate having a cavity, a support film made of an insulating material provided on the semiconductor substrate so as to cover the cavity, and a gauge resistor provided in a region on the support film that covers the cavity, and a humidity detecting element provided on the support film (see the same document, claim 1 and the like).

The semiconductor substrate is formed of single-crystal silicon, and the cavity is formed by a semiconductor microfabrication technique using photolithography and an anisotropic etching technique. The support film includes a single-layer insulating film or a plurality of stacked insulating films. As the insulating film, silicon oxide (SiO₂), silicon nitride (Si₃N₄) or the like is selected.

When manufacturing a sensor element as such a physical quantity detection device, for example, an SiO film or an SiN film is formed on the surface of the semiconductor substrate by a semiconductor microfabrication technique using the above-described photolithography, except for a portion that becomes a cavity of the semiconductor substrate. Then, the semiconductor substrate on which the mask has been formed is subjected to anisotropic etching using a potassium hydroxide solution or the like to form a cavity, thereby exposing the support film.

After that, the SiO film and the SiN film used as the mask are removed with a hydrofluoric acid, a hot phosphoric acid solution, or the like to expose a surface of the semiconductor substrate made of single-crystal silicon. Then, the semiconductor substrate from which the mask has been removed is bonded to a pedestal made of a base material such as glass by, for example, anodic bonding.

### CITATION LIST

### Patent Literature

PTL 1: JP 2016-11889 A

### SUMMARY OF INVENTION

### Technical Problem

As described above, the hydrofluoric acid and hot phosphoric acid solutions used to remove the mask formed on the surface of the semiconductor substrate are highly dangerous, require careful handling, and waste liquid after use. Post-step such as waste liquid processing is required.

In addition, as described above, a multifunctional sensor element including a gauge resistor and a humidity detecting element on a support film may include an SiO film or an SiN film as a support film or a protective film formed thereon. In this case, the entirety of the semiconductor substrate having a mask formed on one surface and a support film and a protective film formed on the other surface is etched with hydrofluoric acid or a hot phosphoric acid solution to remove the mask. Then, the support film and the protective film are removed together with the mask. Therefore, it is necessary to etch only one surface of the semiconductor substrate, which complicates the manufacturing process.

The invention provides a sensor element that can be manufactured without using a hydrofluoric acid or hot phosphoric acid solution, a manufacturing method thereof, and a sensor device.

### Solution to Problem

An aspect of the sensor element of the invention is a sensor element which includes a base material and a semiconductor chip bonded to the base material. The semiconductor chip includes a semiconductor substrate, a support film provided on a surface of the semiconductor substrate, a substrate chamber provided in a concave shape on the semiconductor substrate to form a cavity facing an element region of the support film, and an insulating layer provided in a rear surface of the semiconductor substrate, and a bonding layer provided between the insulating layer and the base material. The insulating layer includes at least one of a silicon oxynitride film and a silicon oxide film. The bonding layer includes a low-melting point glass.

An aspect of the sensor device according to the invention includes the sensor element.

An aspect of the method for manufacturing a sensor element of the invention is a method for manufacturing a sensor element including a base material and a semiconductor chip bonded to the base material. The method includes an arrangement step for arranging a semiconductor chip on a surface of the base material via a bonding agent containing a low-melting point glass in with the insulating layer facing the surface of the base material, wherein the semiconductor chip includes a semiconductor substrate, a support film provided on a surface of the semiconductor substrate, a substrate chamber provided in a concave shape in the semiconductor substrate to form a cavity facing an element region of the support film, and an insulating layer including at least one of a silicon oxynitride film and a silicon oxide film provided on a rear surface of the semiconductor substrate and a bonding step for heating the bonding agent to a heating temperature not lower than a softening point of the low-melting point glass and not higher than a heat-resistant temperature of the semiconductor chip, and bonding the semiconductor chip to the base material via the bonding layer.

### Advantageous Effects of Invention

According to the above aspect of the invention, when the semiconductor substrate of the semiconductor chip is etched to form the substrate chamber, the insulating layer on the rear surface of the semiconductor substrate is used as a mask. Then, the semiconductor chip can be bonded to the base material without removing the insulating layer. Therefore, according to the above aspect of the invention, it is possible to provide a sensor element that can be manufactured without using hydrofluoric acid or hot phosphoric acid solution, a method for manufacturing the same, and a sensor device including the sensor element.

### BRIEF DESCRIPTION OF DRAWINGS

FIG. 1 is a cross-sectional view of a sensor element according to one embodiment of the invention.

FIG. 2 is a plan view of the sensor element illustrated in FIG. 1.

FIG. 3 is a cross-sectional view illustrating a first modification of the sensor element illustrated in FIG. 1.

FIG. 4 is a cross-sectional view illustrating a second modification of the sensor element illustrated in FIG. 1.

FIG. 5 is a cross-sectional view illustrating a third modification of the sensor element illustrated in FIG. 1.

FIG. 6 is a graph illustrating an example of a DTA curve of glass.

FIG. 7 is a cross-sectional view illustrating a fourth modification of the sensor element illustrated in FIG. 1.

FIG. 8A is a bottom view of a sensor device according to one embodiment of the invention.

FIG. 8B is a cross-sectional view of the sensor device taken along line B-B illustrated in FIG. 8A.

FIG. 9A is a cross-sectional view illustrating an example of a mounting state of the sensor device illustrated in FIG. 8B.

FIG. 9B is a cross-sectional view illustrating another example of the mounting state of the sensor device illustrated in FIG. 8B.

FIG. 10A is a cross-sectional view illustrating a mounting state of the sensor device according to one embodiment of the invention.

FIG. 10B is a cross-sectional view of the sensor device taken along line B-B of FIG. 10A.

FIG. 11 is a STEM analysis result of a sensor element bonding interface according to a twelfth example of the invention.

FIG. 12 is a STEM analysis result of a sensor element bonding interface according to the twelfth example of the invention.

### DESCRIPTION OF EMBODIMENTS

Hereinafter, embodiments of a sensor element, a method for manufacturing the same, and a sensor device according to the invention will be described with reference to the drawings.

(Sensor Element and Manufacturing Method Thereof)

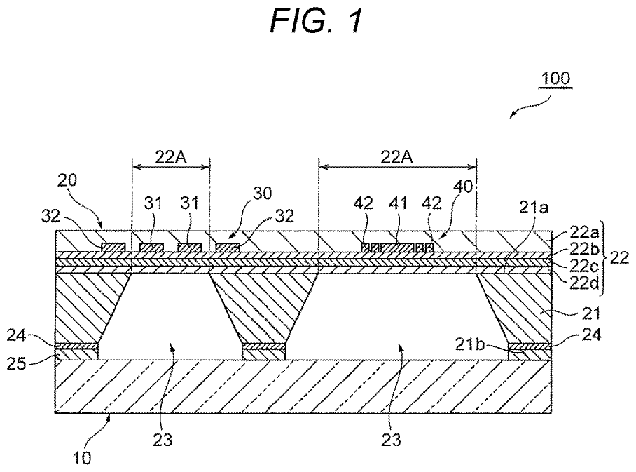

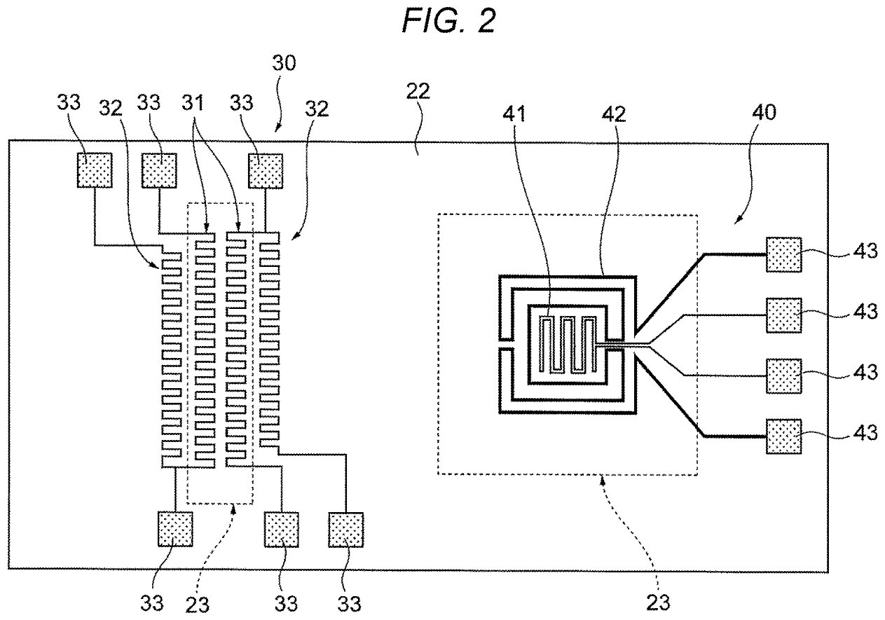

FIG. 1 is a schematic cross-sectional view of a sensor element 100 according to a first embodiment of the invention. FIG. 2 is a schematic plan view of the sensor element 100 illustrated in FIG. 1. The sensor element 100 of this embodiment is used, for example, as a component of a sensor device such as a thermal humidity measuring device that measures the humidity of air passing through an intake pipe of an automobile or such as a multifunctional measuring device that measures both humidity and pressure. The most characteristic feature of the sensor element 100 of this embodiment is that it has the following configuration.

The sensor element 100 includes a base material 10 and a semiconductor chip 20 bonded to the base material 10. The semiconductor chip 20 includes a semiconductor substrate 21, a support film 22 provided on a surface 21a of the semiconductor substrate 21, and a substrate chamber 23 provided in a concave shape on the semiconductor substrate 21 to form a cavity facing an element region 22A of the support film 22, an insulating layer 24 provided on a rear surface 21b of the semiconductor substrate 21, and a bonding layer 25 provided between the insulating layer 24 and the base material 10. The insulating layer 24 includes at least one of a silicon oxynitride film and a silicon oxide film. The bonding layer 25 includes a low-melting point glass. Further, in the sensor element 100 of this embodiment, the thickness of the semiconductor chip 20 is, for example, 10 μm or less. Hereinafter, the configuration of the sensor element 100 of this embodiment will be described in more detail.

The base material 10 is, for example, a plate-shaped member, and is bonded to the rear surface side of the semiconductor chip 20 via the bonding layer 25. The material of the base material 10 is, for example, a semiconductor such as silicon (Si) or glass. As the glass, for example, borosilicate glass such as PYREX (registered trademark) or Tempax Float (registered trademark) can be used. Further, from the viewpoint of improving the bonding reliability between the base material 10 and the semiconductor chip 20, it is preferable that the linear expansion coefficient of the base material 10 may be a value as close as possible to the linear expansion coefficient of the semiconductor substrate 21 of the semiconductor chip 20.

The semiconductor substrate 21 is, for example, a single-crystal silicon substrate made of single-crystal silicon, and has the support film 22 on the surface 21a and the insulating layer 24 on the rear surface. In addition, the semiconductor substrate 21 has the concave substrate chamber 23 that opens at the opening of the insulating layer 24 on the rear surface 21b.

The support film 22 is, for example, an insulator layer or film formed on the surface layer portion of the semiconductor substrate 21 or the surface 21a of the semiconductor substrate 21. In the example illustrated in FIG. 1, the support film 22 has a multilayer structure including a protective film 22a formed on the outermost surface of the semiconductor substrate 21 and three insulating films 22b, 22c, and 22d covered by the protective film 22a. Further, the insulating films 22b, 22c, and 22d forming the support film 22 are not limited to three layers, and may be, for example, a single layer, two layers, or four or more layers. The protective film 22a and the insulating films 22b, 22c, and 22d forming the support film 22 are made of, for example, silicon oxide (SiO_{X}) or silicon nitride (SiN_{X}). The support film 22 includes, for example, the insulating film 22d made of such an oxide or nitride on the surface opposite to the substrate chamber 23.

In the support film 22, for example, at least one of a pressure measurement element 30 and a humidity measurement element 40 is formed in the element region 22A facing the substrate chamber 23 forming a cavity in the semiconductor substrate 21. The pressure measurement element 30 and the humidity measurement element 40 are covered with, for example, a protective film 22a forming the support film 22. The element region 22A of the support film 22 forms a diaphragm or a partition of the substrate chamber 23. Among the insulating films 22b, 22c, and 22d forming the support film 22, the lowermost layer insulating film 22d facing the substrate chamber 23 is made of SiO_{X} or SiN_{X}.

In the example illustrated in FIGS. 1 and 2, the support film 22 has two element regions 22A, the pressure measurement element 30 is formed in one element region 22A, and the humidity measurement element 40 is formed in the other element region 22A. In other words, in the example illustrated in FIGS. 1 and 2, the pressure measurement element 30 and the humidity measurement element 40 are formed on the same support film 22. The support film 22 supports the pressure measurement element 30 and the humidity measurement element 40 on a cavity formed by the substrate chamber 23, respectively.

The substrate chamber 23 is provided in a concave shape on the rear surface 21b side of the semiconductor substrate 21 on which the insulating layer 24 is formed, on the side opposite to the surface 21a side of the semiconductor substrate 21 on which the support film 22 is formed, and forms a cavity facing the element region 22A of the support film 22. The semiconductor chip 20 of this embodiment has two substrate chambers 23. At least one of the substrate chambers 23 is sealed between the semiconductor substrate 21 and the base material 10 and has a depressurized state lower than the atmospheric pressure. In the semiconductor chip 20 of this embodiment, the space between the semiconductor substrate 21 and the base material 10 is sealed in both of the two substrate chambers 23, and the pressure is in a depressurized state lower than the atmospheric pressure. Further, the semiconductor chip 20 may have one substrate chamber 23, or may have three or more substrate chambers 23.

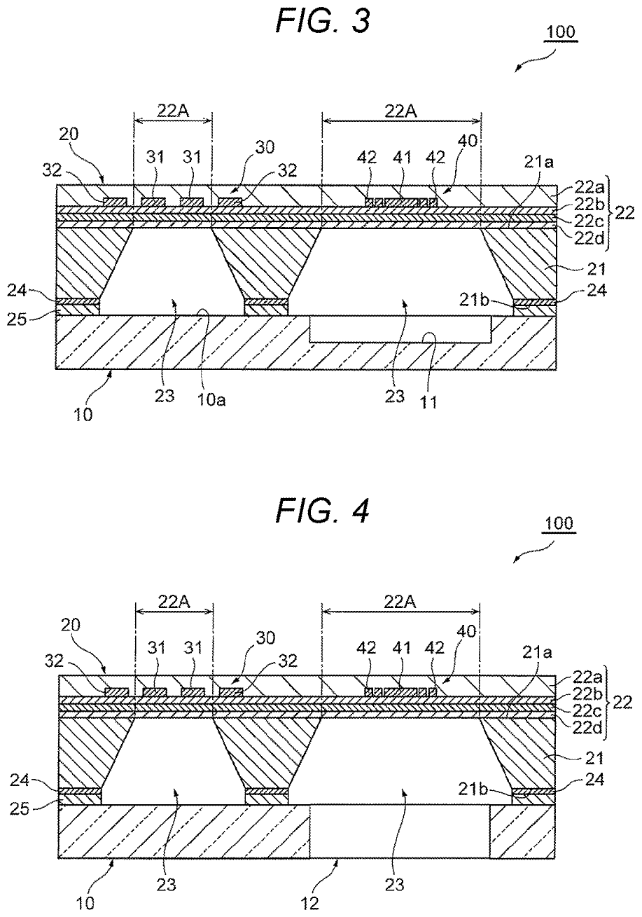

FIG. 3 is a cross-sectional view illustrating a first modification of the sensor element 100 illustrated in FIG. 1. In the example illustrated in FIG. 3, the sensor element 100 has a ventilation groove 11 formed in a concave shape on a surface 10a of the base material 10. The ventilation groove 11 extends from the substrate chamber 23 facing the element region 22A of the support film 22, in which the humidity measurement element 40 is formed, along the surface of the base material 10 toward the side end of the base material 10, and is open at the side end of the base material 10. Thereby, the substrate chamber 23 facing the element region 22A of the support film 22 in which the humidity measurement element 40 is formed communicates with the space around the sensor element 100 through the ventilation groove 11, and has the same pressure as that of the surrounding space.

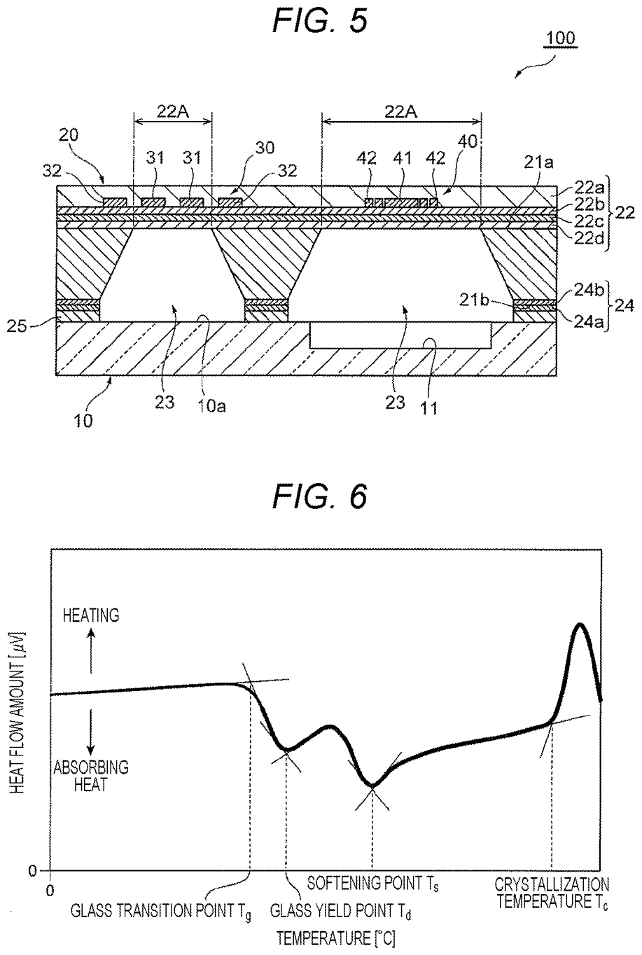

FIG. 4 is a cross-sectional view illustrating a second modification of the sensor element 100 illustrated in FIG. 1. In the example illustrated in FIG. 4, the sensor element 100 has a through hole 12 penetrating the base material 10 in the thickness direction. The through hole 12 extends in the thickness direction of the base material 10 from the substrate chamber 23 facing the element region 22A of the support film 22 in which the humidity measurement element 40 is formed, and opens at the bottom surface of the base material 10. Thereby, the substrate chamber 23 facing the element region 22A of the support film 22 on which the humidity measurement element 40 is formed communicates with the space around the sensor element 100 through the through hole 12, and has the same pressure as the pressure in the surrounding space.

In any case, it is desirable that the substrate chamber 23 facing the element region 22A of the support film 22 on which the pressure measurement element 30 is formed in the depressurized state. The reason is that the internal pressure of the substrate chamber 23 adjacent to the pressure measurement element 30 becomes a reference pressure at the time of pressure measurement by the pressure measurement element 30, and an absolute pressure can be measured. For this purpose, the depressurized state of the substrate chamber 23 is not only a state in which the internal pressure of the substrate chamber 23 is reduced than the atmospheric pressure, but also, for example, it is preferable that the internal pressure of the substrate chamber 23 is a medium vacuum of 100 Pa or less. More preferably, the internal pressure of the substrate chamber 23 is 20 Pa or less.

The pressure measurement element 30 includes, for example, a gauge resistor 31 formed in the element region 22A of the support film 22, a reference resistor 32 formed outside the element region 22A of the support film 22, and a plurality of electrodes 33 connected to the gauge resistor 31 and the reference resistor 32 for transmitting and receiving voltage and current. The gauge resistor 31 and the reference resistor 32 are made of a material having a high temperature coefficient of resistance such as, for example, platinum (Pt), tantalum (Ta), molybdenum (Mo), and polycrystalline silicon (Si) doped with impurities. Molybdenum (Mo) has excellent heat resistance, but the gauge factor of a Mo film is relatively small about 0.4 to 1.5, but the measurement accuracy can be improved by optimizing the shape and structure of the pressure measurement element 30.

In the pressure measurement element 30, the number of the gauge resistors 31 and the number of the reference resistors 32 may be respectively singular, but it is preferable that the number is each plural from the viewpoint of improving the gauge factor and the measurement accuracy. In addition, from the viewpoint of improving the measurement accuracy of the pressure measurement element 30, the thickness of the support film 22 is desirably, for example, a thin film of several tens μm or less. In the examples illustrated in FIGS. 1, 3 and 4, a portion made of single-crystal silicon of the semiconductor substrate 21 adjacent to the element region 22A of the support film 22 is removed to form a cavity substrate chamber 23, and the support film 22 is exposed in the substrate chamber 23. Therefore, by making the support film 22 thin film as described above, the deflection of the support film 22 due to the pressure acting on the support film 22 increases, and the measurement accuracy of the pressure measurement element 30 can be improved.

The humidity measurement element 40 includes, for example, a first heating element 41, a second heating element 42, and a plurality of electrodes 43 connected to these heating elements 41 and 42 for transmitting and receiving voltage and current. The heating elements 41 and 42 are made of, for example, the same material as the gauge resistor 31 of the pressure measurement element 30. From the viewpoint of improving the measurement accuracy of the humidity measurement element 40, the material forming the heating elements 41 and 42 is preferably a material having a temperature coefficient of resistance of 1000 [ppm/° C.] or more and a heat-resistant temperature of 400 [° C.] or more.

In a case where polycrystalline silicon doped with impurities is used as the material of the heating elements 41 and 42 of the humidity measurement element 40 and the gauge resistor 31 and the reference resistor 32 of the pressure measurement element 30, the heat-resistant temperature of these elements is, for example, about 200 [° C.]. Therefore, the material of the humidity measurement element 40 has a problem in reliability for a long period of time. However, the gauge factor of polycrystalline silicon is relatively large, for example, about 3 to 14, and the measurement accuracy of the pressure measurement element 30 can be improved.

Therefore, in a sensor device that is not assumed to be used for a long period of time, materials doped with impurities are effective for the heating elements 41 and 42 of the humidity measurement element 40 of the sensor element 100 and the gauge resistor 31 and the reference resistor 32 of the pressure measurement element 30. However, in the sensor element 100 used for a vehicle-mounted sensor device that is assumed to be used for a long period of time, it is desirable to use a high heat-resistant material such as molybdenum as a material for the heating elements 41 and 42 of the humidity measurement element 40 and the gauge resistor 31 and the reference resistor 32 of the pressure measurement element 30 are used.

The electrodes 33 and 43 of the pressure measurement element 30 and the humidity measurement element 40 are electrically connected, for example, to a drive circuit (not illustrated) via a gold bonding wire or a lead frame. As a material of the electrodes 33 and 43, for example, aluminum (Al) can be used.

The humidity measurement element 40 can measure the humidity as described below, for example. First, the first heating element 41 is controlled to be heated, for example, to a temperature of about 400° C. to 500° C.

In addition, the second heating element 42 is an auxiliary heating element, and is controlled to be heated, for example, to a temperature of about 200° C. to 300° C.

When the humidity of the air changes, the thermal conductivity of the air changes, and the amount of heat radiated from the first heating element 41 to the air changes. The absolute humidity can be measured by detecting the change in the heat release amount.

The second heating element 42 is an auxiliary heating element for maintaining the periphery of the first heating element 41 at a constant temperature. With the second heating element 42, even when the environmental temperature at which the sensor element 100 is installed changes, the vicinity of the first heating element 41 can be maintained at a constant temperature, and the temperature characteristics in humidity measurement can be improved. In this embodiment, the humidity measurement element 40 has the second heating element 42, but the humidity can be measured without the second heating element 42. In a case where the humidity measurement element 40 does not have the second heating element 42, it is necessary to compensate for a measurement error due to a change in air temperature using a temperature sensor or the like as needed.

Further, one factor that causes a measurement error in the humidity measurement element 40 is an error in a case where a high-speed pressure fluctuation occurs. In the example illustrated in FIGS. 3 and 4, the substrate chamber 23 facing the element region 22A of the support film 22 on which the humidity measurement element 40 is formed communicates with the space around the sensor element 100. In this case, the deflection of the support film 22 in the element region 22A where the humidity measurement element 40 is formed can be reduced. Therefore, it is possible to improve the correction accuracy of humidity measured under high-speed pressure and temperature change conditions, and to perform accurate pressure correction even under high-speed pressure fluctuation conditions (transient conditions). In addition, it is possible to suppress a decrease in the correction accuracy of the measured humidity due to a variation at the time of manufacturing.

The pressure measurement element 30 can measure the pressure as follows, for example. Due to the pressure of the gas around the sensor element 100, the element region 22A of the support film 22 facing the cavity formed by the substrate chamber 23 bends, and the resistance of the gauge resistor 31 changes. In other words, since the substrate chamber 23 facing the element region 22A of the support film 22 provided with the pressure measurement element 30 is tightly sealed, the element region 22A of the support film 22 bends due to the pressure of the surrounding gas, and the resistance of the gauge resistor 31 changes. By measuring the resistance change of the gauge resistor 31, the pressure of the gas around the sensor element 100 can be measured.

In addition, in the sensor element 100 of this embodiment, the humidity measurement element 40 and the pressure measurement element 30 are provided on the support film 22 of the semiconductor chip 20. In this case, even if the temperature of the environment around the sensor element 100 changes, the temperature change of the humidity measurement element 40 and the pressure measurement element 30 can be suppressed by the heating elements 41 and 42 of the humidity measurement element 40. Therefore, the influence on the measurement of humidity and the measurement of pressure can be suppressed even under a situation where the temperature changes at high speed.

The insulating layer 24 formed on the rear surface of the semiconductor substrate 21 is at least partially made of, for example, silicon oxide (SiO_{X}) or silicon nitride (SiN_{X}). In the insulating layer 24, for example, in a manufacturing process of the semiconductor chip 20, a pattern having an opening at a position corresponding to the substrate chamber 23 is formed by photolithography. At least a part of the insulating layer 24 is used as a resist when the substrate chamber 23 is formed in the semiconductor substrate 21 by, for example, anisotropic etching from the rear surface of the semiconductor substrate 21 using potassium hydroxide (KOH). At least a part of the insulating layer 24 functioning as a resist may be formed simultaneously with the support film 22 on the surface of the semiconductor substrate 21.

In addition, the insulating layer 24 includes, for example, at least one of a silicon oxynitride film and a silicon oxide film. In other words, the insulating layer 24 may include a multilayer film in which, for example, a single-layer or multi-layer silicon oxynitride film, a single-layer or multi-layer silicon oxide film, or a silicon oxynitride film and a silicon oxynitride film in addition to the portion formed by SiO_{X} or SiN_{X} are laminated. At least one of the silicon oxynitride film and the silicon oxide film is generated, for example, in the process of manufacturing the sensor element 100 when the base material 10 and the semiconductor substrate 21 are bonded via the bonding layer 25, and is a thin film having a thickness of approximately 100 nm or less. Further, in the example illustrated in FIG. 1, the insulating layer 24 is made of only a silicon oxide film.

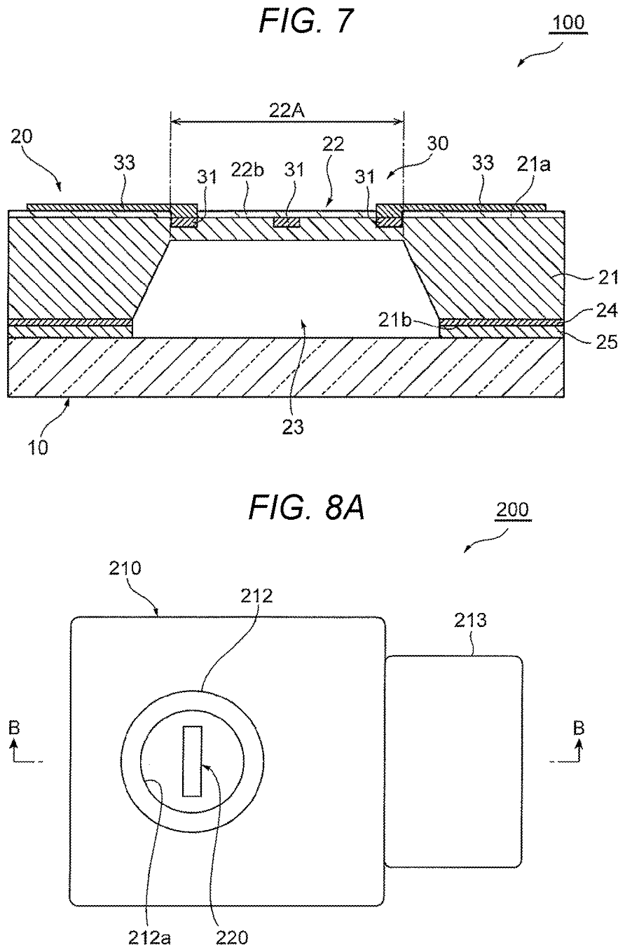

FIG. 5 is a cross-sectional view illustrating a third modification of the sensor element 100 illustrated in FIG. 1. In the example illustrated in FIG. 5, the insulating layer 24 has a two-layer structure including an insulating film 24a made of SiN_{X} and an insulating film 24b made of SiO_{X} from the bonding layer 25 toward the surface 21a of the semiconductor substrate 21. In addition, the support film 22 has a four-layer structure which includes the protective film 22a made of SiO_{X} on the outermost surface, the insulating film 22b made of SiO_{X} in the lower layer thereof, the insulating film 22c made of SiN_{X} in the lower layer thereof, and the insulating film 22d made of SiO_{X} in the lowermost layer.

The bonding layer 25 is a layer containing low-melting point glass. The low-melting point glass forming the bonding layer 25 contains, for example, vanadium. In addition, the low-melting point glass forming the bonding layer 25 has, for example, a linear expansion coefficient of 30×10⁻⁷ [1/° C.] or more and 70×10⁻⁷ [1/° C.] or less. The bonding layer 25 is provided between the base material 10 and the insulating layer 24 provided on the rear surface 21b of the semiconductor substrate 21 forming the semiconductor chip 20, and bonds the semiconductor chip 20 and the base material 10.

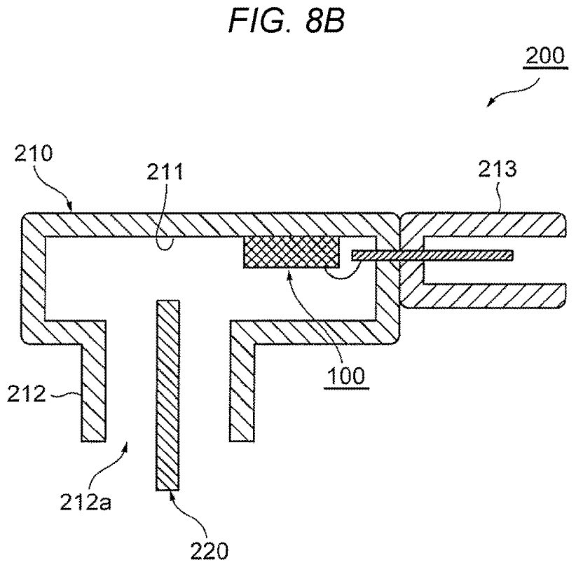

FIG. 6 is a graph illustrating an example of a differential thermal analysis (DTA) curve of glass. Here, the low-melting point glass is a glass having a softening point of 600° C. or lower, where the second endothermic peak is a softening point (Ts), as illustrated in FIG. 6. The low-melting point glass is selected, for example, from those capable of joining the semiconductor chip 20 and the base material 10 at or below the heat-resistant temperature of the semiconductor chip 20. Examples of the low-melting point glass include Bi₂O₃ containing bismuth, SnO containing tin, and V₂O₅ containing vanadium.

In the sensor element 100 of this embodiment, as the low-melting point glass included in the bonding layer 25, for example, V₂O₅ containing vanadium is used, and one containing substantially no lead is used. As a result, it is possible to provide the sensor element 100 compliant with the European Parliament and Council Directive (hereinafter, referred to as the RoHS Directive) on the restriction on the use of specific harmful substances contained in electric and electronic devices. Further, substances banned under the RoHS Directive shall be subject to the Hazardous Substances Regulations enforced by the EU (European Union) on Jul. 1, 2006, and it is acceptable that banned substances are contained within the range specified by the regulations.

Further, in a case where the substrate chamber 23 of the semiconductor chip 20 is in a depressurized state, it is desirable to select SnO-based or V₂O₅-based as the low-melting point glass contained in the bonding layer 25. This is because in a case where the Bi₂O₃-based glass is heated under a depressurized state, the reliability of the bonding layer 25 decreases due to the reduction and precipitation of Bi.

In addition, in a case where the insulating layer 24 is a nitride such as a silicon nitride film, for example, the low-melting point glass contained in the bonding layer 25 is preferably a SnO-based or V₂O₅-based glass. When a Bi₂O₃-based low-melting point glass is converted into a silicon oxide film by a reaction, it reacts with the silicon nitride film to release nitrogen gas and generate bubbles. On the other hand, SnO-based or V₂O₅-based low-melting point glass has low reactivity with the silicon nitride film, suppresses generation of bubbles, and can improve the reliability of the bonding layer 25. In other words, by using the bonding layer 25 containing a SnO-based or V₂O₅-based low-melting point glass, the reaction with the silicon nitride film can be suppressed, and the reaction can be suppressed up to the silicon oxynitride film instead of the silicon oxide film. Thereby, the release of the nitrogen gas can be reduced, and the reliability of the bonding layer can be improved.

The bonding layer 25 can include a filler or the like for adjusting the thermal expansion coefficient, in addition to the low-melting point glass. Examples of the filler may include zircon, zirconia, quartz glass, ß-spondumene, cordierite, mullite, ß-eucryptite, ß-quartz, zirconium phosphate, zirconium phosphate tungstate (ZWP), zirconium tungstate and these solid solutions, and the like. These can be used alone or in combination of two or more. It is desirable that the content of the filler in the bonding layer 25 be 50% by volume or less. If the content is larger than this value, the softening fluidity of the material when forming the bonding layer 25 may be reduced, and the reliability of bonding may be reduced.

The thermal expansion coefficient of the bonding layer 25 is preferably in the range of 30×10⁻⁷ [1/° C.] or more and 70×10⁻⁷ [1/° C.] or less from the viewpoint of bonding reliability. Thereby, the difference in the thermal expansion coefficient from the base material 10 made of, for example, silicon or glass can be reduced, and the bonding reliability can be improved. Here, the thermal expansion coefficient refers to a linear thermal expansion coefficient value measured in a temperature range of 50° C. or more and 250° C. or less.

The most preferable low-melting point glass contained in the bonding layer 25 is a V₂O₅-based low-melting point glass. The V₂O₅-based low-melting point glass has a lower softening point than other low-melting point glasses, and has a linear expansion coefficient that is easier to match with the base material 10 made of silicon or the like. Therefore, a thermal stress when joining the semiconductor chip 20 and the base material 10 via the bonding layer 25 can be reduced. It is desirable that the composition of the V₂O₅-based low-melting point glass further contains 10% by weight or more of Fe₂O₃ in terms of oxidation. By containing 10% by weight or more of Fe₂O₃, it becomes possible to lower the softening point of the glass while lowering the thermal expansion coefficient of the glass composition containing V₂O₅ as a main component.

As a range of the glass composition that can form a good bonding layer 25, for example, in terms of oxidation, V₂O₅ is 45 to 50% by weight, TeO₂ is 20 to 30% by weight, Fe₂O₃ is 10 to 15% by weight, P₂O₅ is 5 to 16% by weight, and WO₃ is 0 to 10% by weight. The glass composition is easily crystallized when Fe₂O₃ is contained in an amount of 10% by weight or more, but the crystallization can be suppressed by containing WO₃ in the range of 0 to 10% by weight.

In addition, the low-melting point glass may contain an alkaline earth metal element in its composition from the viewpoint of thermal stability, but it is desirable to contain the element in a range of less than 10 mol % in terms of oxide. If the range exceeds, the thermal expansion coefficient will increase. The content of the alkali metal element in the low-melting point glass is more preferably 5 mol % or less, more preferably 3.4 mol % or less in terms of oxide.

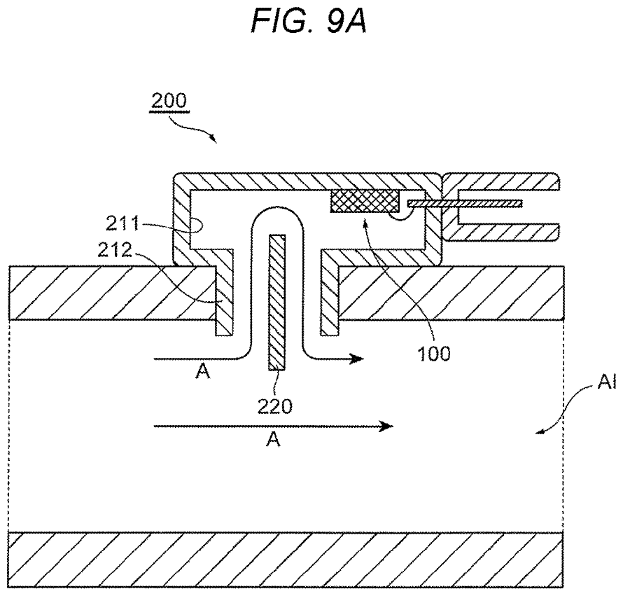

FIG. 7 is a cross-sectional view illustrating a fourth modification of the sensor element 100 illustrated in FIG. 1. The sensor element 100 illustrated in FIG. 7 mainly includes the support film 22 formed by the insulating film 22b, which is an oxide film formed on the surface of the semiconductor substrate 21, and a part of the surface side of the semiconductor substrate 21, and differs from the sensor element 100 illustrated in FIG. 1 in that the humidity measurement element 40 is not included.

In the example illustrated in FIG. 7, the sensor element 100 has the pressure measurement element 30 in the element region 22A of the support film 22 facing the substrate chamber 23 of the semiconductor substrate 21. The insulating film 22b forming a part of the support film 22 is an oxide film formed on the surface of the semiconductor substrate 21, and a region for forming the gauge resistor 31 is opened and removed by photolithography technology. The gauge resistor 31 is formed in a portion of the surface of the semiconductor substrate 21 where the insulating film 22b is opened, for example, by thermal diffusion. The electrode 33 of the pressure measurement element 30 is, for example, an Al electrode formed in a contact hole provided in the insulating film 22b by an oxidation process or a photographic technique.

On the rear surface 21b of the semiconductor substrate 21, the insulating layer 24, which is a SiN_{X} film, is formed. The insulating layer 24 is patterned by a photolithography technique, and has an opening in a portion corresponding to the substrate chamber 23. The substrate chamber 23 is formed by etching the semiconductor substrate 21 with, for example, KOH using the insulating layer 24 as a resist. In the semiconductor chip 20, the rear surface of the semiconductor substrate 21 on which the insulating layer 24 is formed is bonded to the base material 10 via the bonding layer 25. The insulating layer 24 includes at least one of a silicon oxynitride film and a silicon oxide film formed when the insulating layer 24 is bonded to the base material 10 via the bonding layer 25.

Hereinafter, an embodiment of a method for manufacturing a sensor element according to the invention will be described, and an operation of the sensor element 100 according to the above-described embodiment will be described.

The method for manufacturing the sensor element 100 according to this embodiment is a method for manufacturing the sensor element 100 including the above-described base material 10 and the semiconductor chip 20 bonded to the base material 10. The method for manufacturing the sensor element 100 according to this embodiment includes the following arranging step and joining step.

The arranging step is a step of arranging the semiconductor chip 20 via a bonding agent containing low-melting point glass with the insulating layer 24 facing the surface of the base material 10. Here, as described above, the semiconductor chip 20 includes the semiconductor substrate 21, the support film 22 provided on the surface of the semiconductor substrate 21, the substrate chamber 23 forming a cavity facing the element region 22A of the support film 22 provided in a concave shape on the semiconductor substrate 21, and the insulating layer 24 provided on the rear surface of the semiconductor substrate 21 and including at least one of a silicon oxynitride film and a silicon oxide film.

The semiconductor chip 20 can be manufactured, for example, by the following procedure. First, an insulating film forming the support film 22 and the insulating layer 24 is formed on the front and rear surfaces of the semiconductor substrate 21 by, for example, thermal oxidation or chemical vapor deposition (CVD). In addition, the humidity measurement element 40 and the pressure measurement element 30 are formed on the support film 22 by a CVD method or a photolithography technique. In addition, the insulating layer 24 formed on the rear surface of the semiconductor substrate 21 is patterned by photolithography to remove the insulating film forming the insulating layer 24 in the region where the substrate chamber 23 is formed.

Next, using the insulating layer 24 formed on the rear surface of the semiconductor substrate 21 as a resist, the substrate chamber 23 is formed in the semiconductor substrate 21 by anisotropic etching from the rear surface of the semiconductor substrate 21 using potassium hydroxide (KOH). Thus, even in a case where the semiconductor chip 20 has a plurality of substrate chambers 23, the plurality of substrate chambers 23 can be formed collectively. For example, in a case where the semiconductor substrate 21 is made of silicon (Si), the etching is stopped by the difference in etching rate between the semiconductor substrate 21 made of Si and the insulating film made of SiO_{X} forming the support film 22, and the substrate chamber 23 can be easily formed. Further, the insulating film for stopping the etching may be an insulating film made of SiN_{X}. If there is a difference in the etching rate from the semiconductor substrate 21, stable etching can be performed.

The bonding agent is, for example, a paste-like material for forming the bonding layer 25. The bonding agent can be prepared, for example, by kneading the powder of the low-melting point glass, which is an adhesive component, the above-mentioned filler material, a solvent, and a binder. As the solvent, for example, butyl carbitol acetate, α-terpineol, or the like can be used. As the binder, for example, ethyl cellulose, nitrocellulose, or the like can be used.

For example, a low-melting point glass is prepared by mixing and mixing various oxides as raw materials in a platinum crucible, and heated from 800 [° C.] to about 1100 [° C.] using an electric furnace at a heating rate of about 5° C./min to 10° C./min, and manufactured by maintaining the heating temperature for several hours. As long as the heating temperature is maintained, it is desirable to stir the heated and molten material in order to obtain a uniform glass. When removing the crucible from the electric furnace, in order to prevent moisture from adsorbing to the glass surface, it is desirable to pour the melted material onto a graphite mold or stainless steel plate that has been heated to a temperature of about 100° C. to 150° C. in advance.

In the arranging step, first, a paste-like bonding agent is applied to the surface of the base material 10 by a method such as screen printing and dried. Then, the semiconductor chip 20 is arranged on the bonding agent applied to the surface of the base material 10. In order to reduce the pressure in the substrate chamber 23 of the semiconductor chip 20 to a depressurized state lower than the atmospheric pressure, a desired depressurized state is set in a state in which the semiconductor chip 20 is arranged on the surface of the base material 10 via a bonding agent.

The bonding step is a step in which the bonding agent is heated to a heating temperature equal to or higher than the softening point of the low-melting point glass and equal to or lower than the heat-resistant temperature of the semiconductor chip 20 to form the bonding layer 25, and the semiconductor chip 20 is bonded to the base material 10 via the bonding layer 25. In this bonding step, the bonding layer 25 can be formed by performing the binder removal process and the preliminary firing at once. The heating temperature of the bonding agent is preferably, for example, 400° C. or less.

As described above, the sensor element 100 manufactured by the manufacturing method according to this embodiment including the arranging step and the bonding step has the above-described configuration. In other words, the sensor element 100 includes the base material 10 and the semiconductor chip 20 bonded to the base material 10. The semiconductor chip 20 includes a semiconductor substrate 21, a support film 22 provided on the surface of the semiconductor substrate 21, and a substrate chamber 23 provided in a concave shape on the semiconductor substrate 21 to form a cavity facing an element region 22A of the support film 22, an insulating layer 24 provided on the rear surface of the semiconductor substrate 21, and a bonding layer 25 provided between the insulating layer 24 and the base material 10. The insulating layer 24 includes at least one of a silicon oxynitride film and a silicon oxide film. The bonding layer 25 includes a low-melting point glass.

Therefore, according to the sensor element 100 and the method for manufacturing the same of this embodiment, when the semiconductor substrate 21 of the semiconductor chip 20 is etched to form the substrate chamber 23, the insulating film on the rear surface of the semiconductor substrate 21 is used as a mask. Then, the semiconductor chip 20 can be bonded to the base material 10 without removing the insulating film. Therefore, according to this embodiment, it is possible to provide the sensor element 100 that can be manufactured without using a hydrofluoric acid or a hot phosphoric acid solution and a manufacturing method thereof.

In addition, in the sensor element 100 of this embodiment, the semiconductor chip 20 has a plurality of substrate chambers 23 as described above. At least one of the substrate chambers 23 is sealed between the semiconductor substrate 21 and the base material 10 and is in a depressurized state lower than the atmospheric pressure. Accordingly, as described above, the internal pressure of the substrate chamber 23 adjacent to the pressure measurement element 30 becomes the reference pressure at the time of pressure measurement by the pressure measurement element 30 by reducing the substrate chamber 23 facing the element region 22A of the support film 22 in which the pressure measurement element 30 is formed to the depressurized state, so that the absolute pressure can be measured.

In addition, in the sensor element 100 of this embodiment, in a case where the low-melting point glass contained in the bonding layer 25 includes vanadium, as described above, it is possible to comply with the RoHS directive and improve the reliability of the bonding layer 25. Further, the reliability of the sensor element 100 can be improved. Further, in a case where the substrate chamber 23 is in the depressurized state, the reliability of the bonding layer 25 is particularly important in order to maintain the depressurized state in the substrate chamber 23.

In addition, in the sensor element 100 of this embodiment, the support film 22 has a film made of oxide or nitride on the surface on the side opposite to the substrate chamber 23. Therefore, for example, in the etching for forming the substrate chamber 23 in the semiconductor substrate 21, the surface of the semiconductor substrate 21 opposite to the substrate chamber 23 can be protected.

In addition, in the sensor element 100 of this embodiment, in a case where the material of the base material 10 is silicon or glass, the substrate chamber 23 can be formed by etching, and the insulating film can be formed by thermal oxidation.

In addition, in the sensor element 100 of this embodiment, in a case where the insulating layer 24 formed on the rear surface side of the semiconductor substrate 21 includes a silicon nitride film, this silicon nitride film can be used as a resist when the semiconductor substrate 21 is etched to form the substrate chamber 23. In addition, in the sensor element 100 of this embodiment, the semiconductor chip 20 can be bonded to the base material 10 via the bonding layer 25 without removing the silicon nitride film.

In addition, in the sensor element 100 of this embodiment, the insulating layer 24 may include at least one of the silicon oxynitride film and the silicon oxide film between the silicon nitride film and the bonding layer 25 as described above. As described above, these films are thin films having a thickness of about 100 nm or less, which are generated when the base material 10 and the semiconductor substrate 21 are bonded via the bonding layer 25. Therefore, even in this case, the sensor element 100 of this embodiment can bond the semiconductor chip 20 to the base material 10 via the bonding layer 25 without removing the silicon nitride film.

In addition, in the sensor element 100 of this embodiment, as described above, the insulating layer 24 may be formed only of the silicon oxide film. Even in this case, when the semiconductor substrate 21 is etched to form the substrate chamber 23, this silicon oxide film can be used as a resist. In addition, in the sensor element 100 of this embodiment, the semiconductor chip 20 can be bonded to the base material 10 via the bonding layer 25 without removing the silicon oxide film.

In addition, in the sensor element 100 of this embodiment, as described above, the insulating layer 24 may include a silicon oxynitride film having a thickness of 100 nm or less. As described above, this silicon oxynitride film is a thin film formed when the base material 10 and the semiconductor substrate 21 are bonded via the bonding layer 25. Therefore, even in this case, the sensor element 100 of this embodiment can bond the semiconductor chip 20 to the base material 10 via the bonding layer 25 without removing the silicon oxynitride film or the silicon oxide film included in the insulating layer 24.

In addition, in the sensor element 100 of this embodiment, the semiconductor chip 20 has a thickness of 10 μm or less. Thereby, the sensor element 100 can be reduced in size, and the sensor device including the sensor element 100 can be reduced in size.

In addition, in the sensor element 100 of this embodiment, the low-melting point glass contained in the bonding layer 25 has a linear expansion coefficient of 30×10⁻⁷ [1/° C.] or more and 70×10⁻⁷ [1/° C.] or less. Accordingly, as described above, in a case where the base material 10 is silicon or glass, the difference in the thermal expansion coefficient between the base material 10 and the bonding layer 25 is reduced, and the bonding reliability between the semiconductor chip 20 and the base material 10 can be improved.

In addition, in the sensor element 100 of this embodiment, at least one of the pressure measurement element 30 and the humidity measurement element 40 is formed in the element region 22A of the support film 22. Thereby, the sensor element 100 capable of measuring at least one of the pressure and the humidity can be obtained. In addition, in a case where the sensor element 100 includes both the pressure measurement element 30 and the humidity measurement element 40 in the plurality of element regions 22A of the support film 22, as described above, the influence on the measurement of the humidity and the measurement of the pressure can be suppressed even under a condition where the temperature changes at high speed.

In addition, in the method for manufacturing the sensor element 100 of this embodiment, in a case where the heating temperature in the bonding step is 400° C. or lower, the semiconductor chip 20 and the base material 10 can be bonded at a temperature equal to or lower than the heat-resistant temperature of the semiconductor chip 20, so that the reliability of the sensor element 100 can be improved.

(Sensor Device)

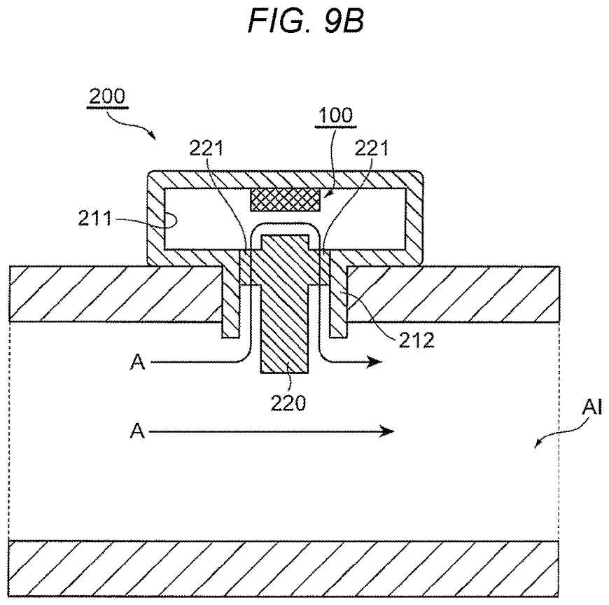

Hereinafter, an embodiment of a sensor device according to the invention will be described with reference to FIGS. 8A and 8B, FIGS. 9A and 9B, and FIGS. 10A and 10B.

FIG. 8A is a bottom view of the sensor device 200 according to an embodiment of the invention. FIG. 8B is a cross-sectional view of the sensor device taken along line B-B illustrated in FIG. 8A.

The sensor device 200 of this embodiment is a thermal humidity detection device including the above-described sensor element 100 illustrated in FIGS. 1 to 5, for example. The sensor device 200 includes a housing 210 that stores the sensor element 100. The housing 210 has a measurement chamber 211 in which the sensor element 100 is arranged, a gas introduction pipe 212 for introducing gas into the measurement chamber 211, and a wiring connector 213 connected to a terminal of an external wiring.

A plate-shaped gas guide 220 is provided in the gas introduction pipe 212 of the housing 210. The gas guide 220 is disposed in the gas introduction pipe 212 and extends along the gas introduction pipe 212. One end of the gas guide 220 protrudes from a gas inlet/outlet 212a of the gas introduction pipe 212, and the other end of the gas guide 220 reaches the measurement chamber 211. As illustrated in FIG. 8A, one end of the gas guide 220 has a gap between the gas guide 220 and the gas inlet/outlet 212a of the gas introduction pipe 212.

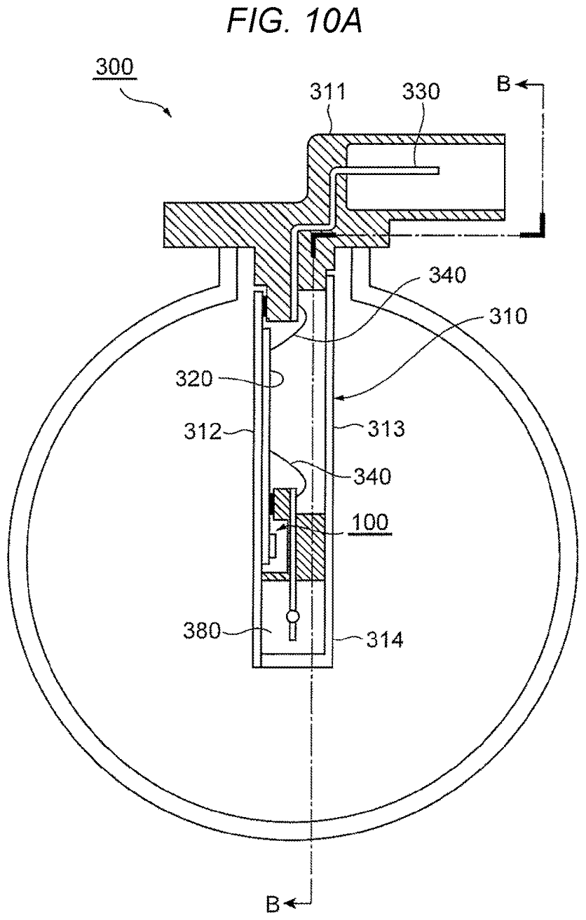

FIG. 9A is a cross-sectional view illustrating an example of a mounting state of the sensor device 200 illustrated in FIG. 8B. In the example illustrated in FIG. 9A, the sensor device 200 is mounted to, for example, an intake passage AI of an automobile. One end of the gas guide 220 of the sensor device 200 protrudes from the gas inlet/outlet 212a of the gas introduction pipe 212 toward the center line of the intake passage AI. Therefore, when a gas such as air A flowing through the intake passage AI hits one end of the gas guide 220, a differential pressure is generated between the upstream side and the downstream side of the gas guide 220, and the gas flows through the gas introduction pipe 212.

More specifically, the gas on the upstream side of the gas guide 220 is introduced into the gas introduction pipe 212 from the gas inlet/outlet 212a of the gas introduction pipe 212, flows through the gas introduction pipe 212 along the gas guide 220, and reaches the measurement chamber 211. The gas that has reached the measurement chamber 211 flows through the gas introduction pipe 212 from the measurement chamber 211 along the gas guide 220, reaches the gas inlet/outlet 212a, and is discharged from the gas inlet/outlet 212a to the downstream side of the gas guide 220. Thereby, the gas flowing through the intake passage AI is introduced around the sensor element 100, and the responsiveness of the sensor device 200 can be improved.

As described above, in the sensor device 200 of this embodiment, one end of the gas guide 220 has a gap between the one end of the gas guide 220 and the gas inlet/outlet 212a of the gas introduction pipe 212. Accordingly, a gas passage is secured all around the gas inlet/outlet 212a around the gas guide 220, and the gas can be actively introduced to the gas inlet/outlet 212a of the gas introduction pipe 212 by the gas guide 220 regardless of the flowing direction of the gas. With this configuration, the responsiveness of the sensor device 200 to a change in the humidity of the gas can be improved.

FIG. 9B is a cross-sectional view illustrating another example of the mounting state of the sensor device 200 illustrated in FIG. 8B. The sensor device 200 illustrated in FIG. 9B is mounted to, for example, the intake passage AI of an automobile in a state where the sensor device 200 illustrated in FIG. 9A is rotated by 90°, similarly to the sensor device 200 illustrated in FIG. 9A. The other end of the gas guide 220 protruding from the gas inlet/outlet 212a opposite to the one end of the gas introduction pipe 212 is fixed to the gas introduction pipe 212 via a support 221 extending in the radial direction of the gas introduction pipe 212.

As described above, when the gas flowing in the intake passage AI hits one end of the gas guide 220, a differential pressure occurs between the upstream side and the downstream side of the gas guide 220, and the gas flows through the gas introduction pipe 212. Here, in the sensor device 200 of this embodiment, one end of the gas guide 220 has a space between the gas guide 220 and the gas inlet/outlet 212a of the gas introduction pipe 212. Therefore, similarly to the sensor device 200 illustrated in FIG. 9A, the gas on the upstream side of the gas guide 220 is introduced into the gas introduction pipe 212 from the gas inlet/outlet 212a of the gas introduction pipe 212, and the gas flows through the gas introduction pipe 212 along the gas guide 220 and reaches the measurement chamber 211. The gas that has reached the measurement chamber 211 flows through the gas introduction pipe 212 from the measurement chamber 211 along the gas guide 220, reaches the gas inlet/outlet 212a, and is discharged from the gas inlet/outlet 212a to the downstream side of the gas guide 220. Thereby, the gas flowing through the intake passage AI is introduced around the sensor element 100, and the responsiveness of the sensor device 200 can be improved.

Therefore, according to the sensor device 200 of this embodiment, a high-speed response to a change in humidity can be realized regardless of the mounting direction of the sensor device 200 with respect to the flow of gas. Here, the high-speed response is, for example, a response that is shorter than the response time of the humidity-sensitive film type humidity sensor. For example, the output of the sensor device 200 follows a change in humidity of a step shape according to a transition of time within one second. In addition, since the mounting direction of the sensor device 200 is not limited, various layouts can be supported.

In addition, according to the sensor device 200 of this embodiment, it is possible to measure the humidity even in a place where the flowing direction of the gas is not uniform, such as the intake passage AI of an automobile. In other words, it is possible to mount the sensor device 200 even in a place such as an intake manifold where gas flows randomly in many directions instead of one direction, and it is possible to measure humidity near the engine, which was conventionally impossible.

In particular, the intake manifold has more pollutants such as moisture and dust than the intake passage AI. However, since the sensor element 100 of the sensor device 200 is heated to a high temperature, deterioration of the sensor element 100 over time due to contaminants can be suppressed, and measurement of humidity in the intake manifold can be performed. In addition, the sensor device 200 of this embodiment can measure the humidity by the sensor element 100 also in the intake manifold, and thus can measure the humidity at a location closer to the engine. Therefore, the sensor device 200 of this embodiment can contribute to more accurate engine control.

Further, since the sensor element 100 of the sensor device 200 dissipates heat by the flow of gas, a measurement error of humidity may occur due to the flow of gas. Therefore, as a more preferable example, by arranging the sensor element 100 in a place not exposed to the main flow of gas, it is possible to suppress an error in detection of humidity due to the flow of gas. Specifically, as illustrated in FIG. 9A, the sensor element 100 may be arranged at a position hidden from the opening of the gas introduction pipe 121, that is, a position radially outside the gas introduction pipe 212 from the gas introduction pipe 212 in the measurement chamber 211 of the housing 210.

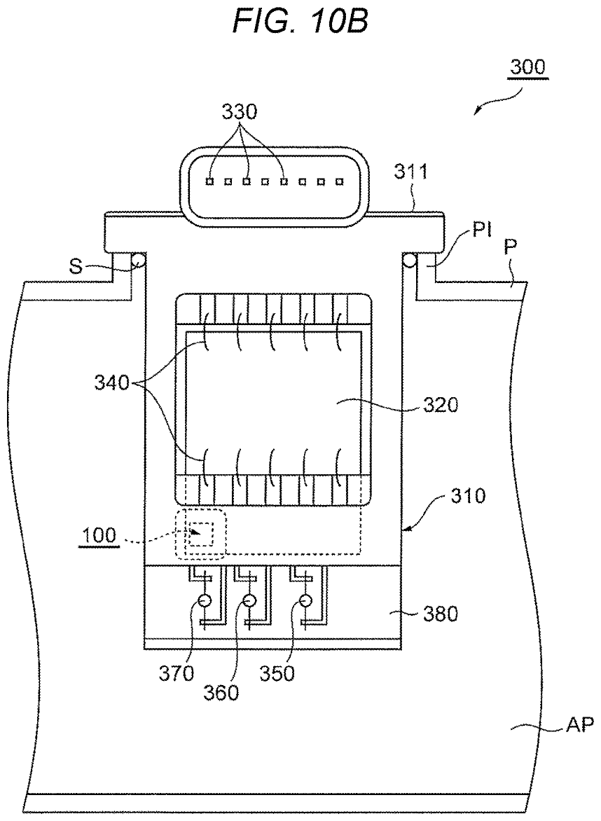

FIG. 10A is a cross-sectional view illustrating a mounting state of the sensor device 300 according to an embodiment of the invention. FIG. 10B is a cross-sectional view taken along line B-B of FIG. 10A. The sensor device 300 of this embodiment includes the above-described sensor element 100 illustrated in FIGS. 1 to 5, for example. The sensor device 300 of this embodiment is a multifunctional measuring device in which a humidity sensor, an airflow sensor, and a pressure sensor are integrated.

The sensor device 300 of this embodiment is mounted, for example, to an insertion port PI of an air passage component P forming a main air passage AP. The sensor device 300 includes, for example, a housing 310 and the sensor element 100 housed inside the housing 310. The housing 310 includes a housing component 311, a base member 312, a cover member 313, and an auxiliary air passage forming member 314.

An electronic circuit board 320 is fixed inside the base member 312. The housing component 311 has a flange-like shape mounted to the insertion port PI of the air passage component P, and the space between the housing component 311 and the insertion port PI is sealed by a seal member S. In addition, a part of the housing component 311 is a connector portion connected to a terminal of an external wiring, and a connector terminal 330 is insert-molded. The connector terminal 330 is connected to a circuit of the electronic circuit board 320 via a bonding member 340.

The electronic circuit board 320 is provided with the sensor element 100, a heat generating resistor 350, a temperature compensating resistor 360, and an intake air temperature sensor 370. The electrodes 33 and 43 of the pressure measurement element 30 and the humidity measurement element 40 of the sensor element 100 are connected to the circuit of the electronic circuit board 320. The heat generating resistor 350, the temperature compensating resistor 360, and the intake air temperature sensor 370 are respectively connected to the circuit of the electronic circuit board 320 via the bonding member 340, and are disposed in an auxiliary air passage 380 which is formed by the auxiliary air passage forming member 314.

The connector terminal 330 is connected to the sensor element 100, the heat generating resistor 350, the temperature compensating resistor 360, and the intake air temperature sensor 370 via the bonding member 340 and the circuit of the electronic circuit board 320, and inputs and outputs signals and supplies power. The space around the sensor element 100 is defined by members forming the housing 310 and communicates with the auxiliary air passage 380. With this configuration, the humidity can be accurately measured, and the sensor element 100 contained in the gas to be measured can be isolated from the polluting substances and water droplets.

As described above, the embodiment of the invention has been described in detail with reference to the drawings. However, the specific configuration is not limited to this embodiment, and there are design changes and the like without departing from the gist of the invention, which are also included in the invention.

### EXAMPLES

Hereinafter, examples of the sensor element according to the invention will be described.

First, a low-melting point glass contained in a bonding layer for bonding the semiconductor chip and the base material is manufactured. In addition, two types of commercially available SnO—P₂O₅-based low-melting point glasses are prepared. Table 1 illustrates the compositions and softening points Ts of the 13 types of manufactured low-melting point glasses (glass Nos. G1 to G13) and the softening point Ts of commercially available low-melting point glass (glass No. G14). Further, in the manufactured low-melting point glasses Nos. G1 to G13, lead is not substantially contained in consideration of environment and safety.

TABLE 1

| Glass | Glass Composition [% by Weight] | | | | | | | | | | | | Ts |
|---|---|---|---|---|---|---|---|---|---|---|---|---|---|
| No. | V₂O₅ | TeO₂ | Fe₂O₃ | P₂O₅ | WO₃ | BaO | Nb₂O₅ | K₂O | Bi₂O₃ | B₂O₃ | ZnO | CuO | [° C.] |
| G1 | 50 | 20 | 10 | 15 | 5 | — | — | — | — | — | — | — | 357 |
| G2 | 50 | 25 | 10 | 15 | — | — | — | — | — | — | — | — | 362 |
| G3 | 47 | 30 | 10 | 13 | — | — | — | — | — | — | — | — | 364 |
| G4 | 47 | 20 | 10 | 13 | 10 | — | — | — | — | — | — | — | 367 |
| G5 | 47 | 25 | 10 | 13 | 5 | — | — | — | — | — | — | — | 356 |
| G6 | 47 | 20 | 10 | 15 | 8 | — | — | — | — | — | — | — | 367 |
| G7 | 45 | 22 | 12 | 16 | 5 | — | — | — | — | — | — | — | 372 |
| G8 | 45 | 30 | 15 | 10 | — | — | — | — | — | — | — | — | 377 |
| G9 | 45 | 25 | — | 10 | 10 | 10 | — | — | — | — | — | — | 364 |
| G10 | 45 | 29.5 | 5 | 10 | 5 | 5 | 0.5 | — | — | — | — | — | 355 |
| G11 | 40 | 30 | — | 5 | 10 | 15 | — | — | — | — | — | — | 357 |
| G12 | 47 | 30 | 7 | 10 | 5 | — | — | — | — | — | 1 | — | 353 |
| G13 | — | — | 0.4 | — | — | 3.4 | — | — | 76.8 | 8.1 | 6.3 | 5 | 450 |

| | | |
|---|---|---|
| G14 | Commercial Product (SnO-P₂O₅-based) | 398 |
| G15 | Commercial Product (SnO-P₂O₅-based) | — |

The production of the low-melting point glass is performed according to the following procedure. First, the raw material compounds are blended and mixed so as to have the composition illustrated in Table 1. As the raw material compounds, vanadium pentoxide, tellurium oxide, ferric oxide, phosphorus pentoxide, tungsten oxide, barium oxide, niobium oxide, potassium oxide, bismuth oxide, boron oxide, zinc oxide, and copper oxide are used.

Next, 1 kg of the mixed raw material compounds is put in a platinum crucible, and heated to 1,000° C. at a heating rate of 5 to 10 [° C./min] by an electric furnace, and the heating temperature is maintained for 2 hours. While maintaining the heating temperature, the molten raw material compound is stirred to obtain a uniform glass. Next, the platinum crucible is taken out of the electric furnace, and poured onto a stainless steel plate which has been heated to 100° C. in advance to obtain a low-melting point glass.

The obtained glasses Nos. G1 to G13 low-melting point glass and the commercially available glass No. G14 low-melting point glass are pulverized until the average particle diameter (D50) becomes less than 20 μm, and the softening point Ts is measured by performing differential thermal analysis (DTA) at a heating rate of 5° C./min. Further, alumina powder is used as a standard sample. In the DTA curve, the softening point is the temperature of the second endothermic peak.

Next, a paste-like bonding agent for forming a bonding layer for bonding the semiconductor chip and the base material is prepared. Specifically, low-melting point glasses Nos. G1 to G15 are first pulverized using a jet mill until the average particle diameter (D50) became about 3 μm. In addition, a predetermined amount of Zr₂ (WO₄) (PO₄)₂ (hereinafter, referred to as ZWP) is added to glass as a filler having an average particle diameter (D50) of about 3 μm. Ethyl cellulose as a binder resin and butyl carbitol acetate as a solvent are added to the mixture and kneaded to prepare a paste-like bonding agent.

Next, a semiconductor substrate made of silicon is prepared, and the semiconductor chip 20 having the configuration illustrated in FIG. 5 described in the above embodiment is manufactured by thermal oxidation, CVD, etching using photolithography, or the like. Further, the protective film 22a and the insulating films 22b and 22d forming the support film 22, and the insulating films 24a and 24b forming the insulating layer 24 are silicon oxide films (SiO_{X} films), and the insulating film 22c forming the support film 22 is a silicon nitride film (SiN_{X} film). Molybdenum (Mo) is used for the gauge resistor 31 and the reference resistor 32 of the pressure measurement element 30, and aluminum (Al) is used for the electrode 33.

Next, using Pyrex (registered trademark) as a base material, a paste-like bonding agent prepared on the substrate is applied by screen printing, and dried at a temperature of 150° C. for several minutes. Thereafter, calcination is performed in a temperature range of 30° C. to 50° C. higher than the softening point Ts of the low-melting point glass contained in the bonding agent. After that, a semiconductor chip is arranged on the base material via the temporarily baked bonding agent, and the surrounding atmosphere is reduced to a depressurized state of 20 Pa or less. In this state, the bonding agent is heated at a predetermined heating temperature for 10 minutes to form a bonding layer, and the semiconductor chip and the base material are bonded via the bonding layer.

Through the above procedure, the sensor elements of the first to sixteenth examples are manufactured. In addition, a sensor element of a first comparative example is manufactured by applying an anode voltage of 500 [V] at a temperature of 400 [° C.] and applying a voltage of 500 [V] so as to anodic-bond the semiconductor chip and the base material without using a bonding agent. Table 2 below illustrates the configuration of the bonding agent, the thermal expansion coefficient of the bonding layer, the bonding conditions, and the bonding atmosphere used in the sensor element of each example.

TABLE 2

| | Configuration of Bonding Agent | | | | Thermal | | |
|---|---|---|---|---|---|---|---|
| | | Content | | Content | Expansion | | |
| | Glass | [% by | | [% by | Coefficient | Bonding | Bonding |
| | No. | Volume] | Filler | Volume] | [x10⁻⁷/° C.] | Condition | Atmosphere |
| First | G1 | 70 | ZWP | 30 | 50 | 400° C.-10 min | Vacuum |
| Example | | | | | | | |
| Second | G2 | 70 | ZWP | 30 | 58 | 400° C.-10 min | Vacuum |
| Example | | | | | | | |
| Third | G3 | 70 | ZWP | 30 | 60 | 400° C.-10 min | Vacuum |
| Example | | | | | | | |
| Fourth | G4 | 70 | ZWP | 30 | 44 | 400° C.-10 min | Vacuum |
| Example | | | | | | | |
| Fifth | G5 | 70 | ZWP | 30 | 52 | 390° C.-10 min | Vacuum |
| Example | | | | | | | |
| Sixth | G6 | 70 | ZWP | 30 | 49 | 400° C.-10 min | Vacuum |
| Example | | | | | | | |
| Seventh | G7 | 70 | ZWP | 30 | 47 | 400° C.-10 min | Vacuum |
| Example | | | | | | | |
| Eighth | G8 | 70 | ZWP | 30 | 54 | 400° C.-10 min | Vacuum |
| Example | | | | | | | |
| Ninth | G9 | 70 | ZWP | 30 | 76 | 400° C.-10 min | Vacuum |
| Example | | | | | | | |
| Tenth | G10 | 70 | ZWP | 30 | 62 | 390° C.-10 min | Vacuum |
| Example | | | | | | | |
| Eleventh | G11 | 70 | ZWP | 30 | 86 | 400° C.-10 min | Vacuum |
| Example | | | | | | | |
| Twelfth | G12 | 60 | ZWP | 40 | 37 | 400° C.-10 min | Vacuum |
| Example | | | | | | | |
| Thirteenth | G13 | 70 | ZWP | 30 | 66 | 500° C.-10 min | Vacuum |
| Example | | | | | | | |
| Fourteenth | G4 | 60 | ZWP | 40 | 32 | 400° C.-10 min | Vacuum |
| Example | | | | | | | |
| Fifteenth | Commercial Product | | | | 70 | 430° C.-10 min | Vacuum |
| Example | (SnO-P₂O₅-based) | | | | | | |
| Sixteenth | Commercial Product | | | | 52 | 430° C.-10 min | Vacuum |
| Example | (SnO-P₂O₅-based) | | | | | | |
| First | Anodic Bonding | | | | — | 400° C.-500 V | Vacuum |
| Comparative | | | | | | | |
| Example | | | | | | | |

With respect to the manufactured sensor elements of the first to sixteenth examples and the first comparative example, the bonding state of the semiconductor chip and the base material, the presence or absence of metal particles, the generation state of bubbles, and the operation are confirmed and evaluated.

Regarding the bonding state of the semiconductor chip and the base material, the semiconductor chip and the base material are integrally bonded, the substrate chamber is in a depressurized state, and the support film is dented in a concave shape, which is determined as “good”. It is determined that the bonding cannot be performed as “impossible”. In addition, when a plurality of sensor elements are manufactured, most of the bonding states are “good”, but those in which “impossible” is present is determined to be “possible”.

The presence or absence of metal particles and the generation state of bubbles are evaluated by observing the cross section of the sensor element by SEM. Then, it is determined as “good” in a case where the number of bubbles of 10 μm or more is 20 or less in the bonding portion including the bonding layer, “possible” in the case of 20 or more and 100 or less, and “impossible” in the case of 100 or more.

Regarding the operation of the sensor element, the electrodes of the pressure measurement element and the humidity measurement element are wire-bonded to the circuit board, and it is confirmed whether the output voltage value is within a normal value range. In a case where all were normal, it is determined as “good”. In a case where a plurality of sensor elements are manufactured, and not only normal ones, but also ones that output abnormal values or caused communication failure, it is determined as “possible”, and others are determined as “impossible”. The results are illustrated in Table 3 below.

TABLE 3

| | | Precipitation of | | |
|---|---|---|---|---|
| | Bonding State | Metal Particles | Bubbles | Operation |
| First | Good | None | Good | Good |
| Example | | | | |
| Second | Good | None | Good | Good |
| Example | | | | |
| Third | Good | None | Good | Good |
| Example | | | | |
| Fourth | Good | None | Good | Good |
| Example | | | | |
| Fifth | Good | None | Good | Good |
| Example | | | | |
| Sixth | Good | None | Good | Good |
| Example | | | | |
| Seventh | Good | None | Good | Good |
| Example | | | | |
| Eighth | Good | None | Good | Good |
| Example | | | | |
| Ninth | Possible | None | Good | Good |
| Example | | | | |
| Tenth | Good | None | Good | Good |
| Example | | | | |
| Eleventh | Possible | None | Good | Good |
| Example | | | | |
| Twelfth | Good | None | Good | Good |
| Example | | | | |
| Thirteenth | Good | Present | Possible | Possible |
| Example | | | | |
| Fourteenth | Good | None | Good | Good |
| Example | | | | |
| Fifteenth | Good | None | Good | Possible |
| Example | | | | |
| Sixteenth | Good | None | Good | Possible |
| Example | | | | |
| First | Impossible | — | — | — |
| Comparative | | | | |
| Example | | | | |

From the above results, the semiconductor chips of the sensor elements of the first to sixteenth example are successfully bonded to the base material without being subjected to an etching step of removing the insulating layer even in a case where the sensor layer has an insulating layer on the rear surface of the semiconductor substrate because the bonding layer contains low-melting point glass. On the other hand, in the sensor element of the first comparative example in which anodic bonding is performed, the semiconductor chip having the insulating layer on the rear surface of the semiconductor substrate and the base material cannot be bonded.

In addition, it has been found out that the absolute pressure can be measured by the pressure measurement element of the sensor element by setting the substrate chamber of the semiconductor chip to a depressurized state lower than the atmospheric pressure. At this time, a desirable range for the thermal expansion coefficient of the bonding layer is a region of 70×10⁻⁷/° C. or less. In addition, from the viewpoints of precipitation of metal particles and bubbles, V₂O₅-based and SnO-based low-melting point glass are desirable as the low-melting point glass contained in the bonding layer. Further, considering the operation of the sensor element, the most desirable is a V₂O₅-based low-melting point glass. This is because the bonding temperature between the semiconductor chip and the base material can be reduced to 400° C. or less.

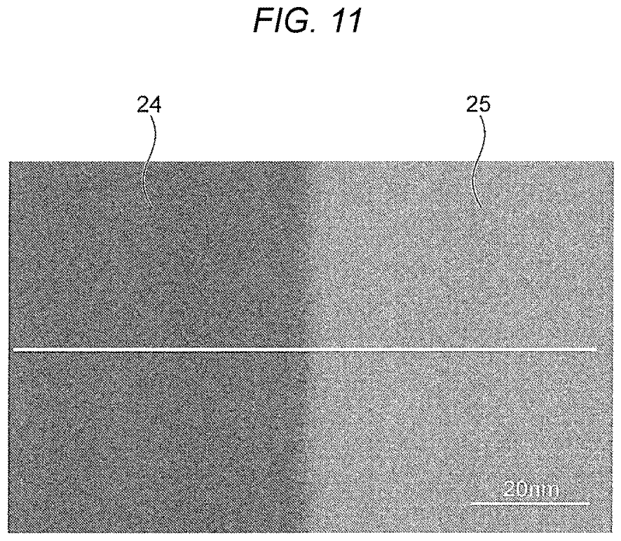

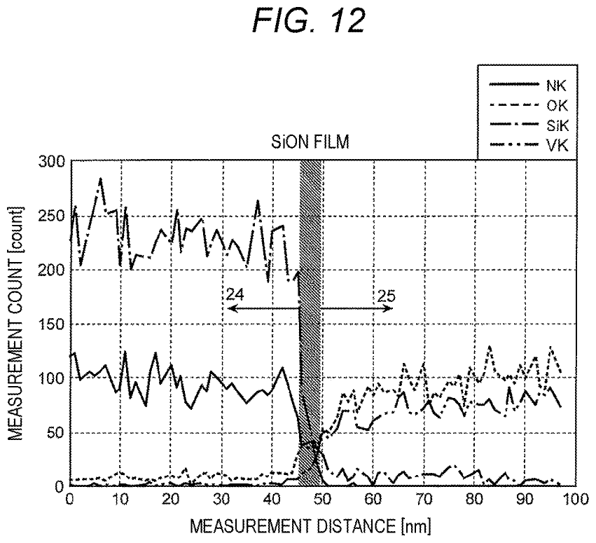

In addition, FIGS. 11 and 12 illustrates the results of STEM analysis of the bonding interface between the insulating layer 24 and the bonding layer 25 of the sensor element of the twelfth example. As a result, it has been found out that the low-melting point glass and the silicon nitride film reacted at the bonding interface between the insulating layer 24 and the bonding layer 25 to form a silicon oxynitride film of about 2 nm. In the sensor element of the twelfth example, the number of bubbles is small at the interface between the insulating layer 24 and the bonding layer 25, presumably because the reactivity between the low-melting point glass and the silicon nitride film is low.

Next, the sensor elements of seventeenth to nineteenth examples are manufactured in the same manner as in the first to sixteenth examples except that the insulating layer 24 is a single-layer silicon oxide film. As the low-melting point glass contained in the bonding layers of the sensor elements of the seventeenth, eighteenth, and nineteenth examples, those used in the twelfth, thirteenth, and fifteenth examples, respectively, are used. Table 4 below illustrates the configuration of the bonding agent used in the sensor element of each example, the thermal expansion coefficient of the bonding layer, the bonding conditions, and the bonding atmosphere.

TABLE 4

| | Configuration of Bonding Agent | | | | Thermal | | |
|---|---|---|---|---|---|---|---|
| | | Content | | Content | Expansion | | |
| | Glass | [% by | | [% by | Coefficient | Bonding | Bonding |
| | No. | Volume] | Filler | Volume] | [x10⁻⁷/° C.] | Condition | Atmosphere |
| Seventeenth | G12 | 60 | ZWP | 40 | 37 | 400° C.-10 min | Vacuum |
| Example | | | | | | | |
| Eighteenth | G13 | 70 | ZWP | 30 | 66 | 500° C.-10 min | Vacuum |
| Example | | | | | | | |
| Nineteenth | Commercial Product | | | | 70 | 430° C.-10 min | Vacuum |
| Example | (SnO-P₂O₅-based) | | | | | | |
| First | Anodic Bonding | | | | — | 400° C.-500 V | Vacuum |
| Comparative | | | | | | | |
| Example | | | | | | | |

In addition, the evaluation of the sensor elements of the seventeenth to nineteenth examples is performed in the same manner as in the first to sixteenth examples. Table 5 below illustrates the evaluation results of the sensor elements of the seventeenth to nineteenth examples together with the evaluation results of the sensor element of the first comparative example described above.

TABLE 5

| | | | Precipitation | | |
|---|---|---|---|---|---|
| | Bonding | Bonding | of Metal | | Opera- |
| | Atmosphere | Possibility | Particles | Bubbles | tion |
| Seventeenth | Vacuum | Good | None | Good | Good |
| Example | | | | | |
| Eighteenth | Vacuum | Good | Present | Good | Possible |
| Example | | | | | |
| Example 19 | Vacuum | Good | None | Good | Possible |
| Comparative | Vacuum | Impossible | — | — | — |
| Example 1 | | | | | |

From the above results, it is confirmed that, in the sensor elements of the seventeenth to nineteenth examples in which the insulating layer formed on the rear surface of the semiconductor chip is a silicon oxide film, the same results as those of the sensor elements of the first to sixteenth examples are obtained.

### REFERENCE SIGNS LIST

10 base material
20 semiconductor chip
21 semiconductor substrate
21a surface
21b rear surface
22 support film
22A element region
23 substrate chamber
24 insulating layer
25 bonding layer
30 pressure measurement element
40 humidity measurement element
100 sensor element
200 sensor device
300 sensor device

1. A sensor element including a base material and a semiconductor chip bonded to the base material,
wherein the semiconductor chip includes a semiconductor substrate, a support film provided on a surface of the semiconductor substrate, a substrate chamber provided in a concave shape on the semiconductor substrate to form a cavity facing an element region of the support film, and an insulating layer provided in a rear surface of the semiconductor substrate, and a bonding layer provided between the insulating layer and the base material,
wherein the insulating layer includes at least one of a silicon oxynitride film and a silicon oxide film, and
wherein the bonding layer includes a low-melting point glass.

2. The sensor element according to claim 1,
wherein the semiconductor chip includes a plurality of the substrate chambers, and
wherein at least one of the substrate chambers is sealed between the semiconductor substrate and the base material and is in a depressurized state lower than the atmospheric pressure.

3. The sensor element according to claim 1,
wherein the low-melting point glass contains vanadium.

4. The sensor element according to claim 1,
wherein the support film has a film made of an oxide or a nitride on a surface opposite to the substrate chamber.

5. The sensor element according to claim 1,
wherein the base material is silicon or glass.

6. The sensor element according to claim 1,
wherein the insulating layer includes a silicon nitride film.

7. The sensor element according to claim 6,
wherein the insulating layer has at least one of the silicon oxynitride film and the silicon oxide film between the silicon nitride film and the bonding layer.

8. The sensor element according to claim 1,
wherein the insulating layer is formed only of the silicon oxide film.

9. The sensor element according to claim 1,
wherein the insulating layer has the silicon oxynitride film, and
wherein the silicon oxynitride film has a thickness of 100 nm or less.

10. The sensor element according to claim 1,
wherein the semiconductor chip has a thickness of 10 μm or less.

11. The sensor element according to claim 1,
wherein the low-melting point glass has a linear expansion coefficient of 30×10⁻⁷ [1/° C.] or more and 70×10⁻⁷ [1/° C.] or less.

12. The sensor element according to claim 1,
wherein at least one of a pressure measurement element and a humidity measurement element is formed in the element region of the support film.

13. A sensor device, comprising:
the sensor element according to claim 1.

14. A method for manufacturing a sensor element including a base material and a semiconductor chip bonded to the base material, comprising:
an arrangement step for arranging a semiconductor chip on a surface of the base material via a bonding agent containing a low-melting point glass in with the insulating layer facing the surface of the base material, wherein the semiconductor chip includes a semiconductor substrate, a support film provided on a surface of the semiconductor substrate, a substrate chamber provided in a concave shape in the semiconductor substrate to form a cavity facing an element region of the support film, and an insulating layer including at least one of a silicon oxynitride film and a silicon oxide film provided on a rear surface of the semiconductor substrate; and
a bonding step for heating the bonding agent to a heating temperature not lower than a softening point of the low-melting point glass and not higher than a heat-resistant temperature of the semiconductor chip, and bonding the semiconductor chip to the base material via the bonding layer.

15. The method for manufacturing a sensor element according to claim 14, wherein, in the bonding step, the heating temperature is 400° C. or less.
